(19) United States
(12) Patent Application Publication
(10) Pub. No.: US 2024/0185405 A1
(43) Pub. Date: Jun. 6, 2024

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: YOSUKE TAKADA, Kanagawa (JP)

(21) Appl. No.: 18/489,757

(22) Filed: Oct. 18, 2023

(30) Foreign Application Priority Data
Oct. 21, 2022 (JP) 2022-169200

(51) Int. Cl. G06T 7/00; G06T 5/50

(52) U.S. Cl. CPC G06T 7/0002; G06T 5/50; G06T 2207/20081; G06T 2207/20084; G06T 2207/20221

(57) ABSTRACT

A plurality of items of input image data is acquired, and processing is performed using a neural network based on N (N is an integer greater than or equal to 2) items of input image data among the plurality of items of input image data to output N items of image data corresponding to the N items of input image data.

### BACKGROUND

### Field of the Disclosure

The present disclosure relates to information processing techniques for restoring degraded videos.

### Description of the Related Art

In recent years, deep neural networks (DNNs) have been applied to applications that restore degradation of images and videos. A DNN refers to a neural network with two or more hidden layers, and, by increasing the number of hidden layers, the performance has been improved. In the case of restoring video degradation, temporal consistency is an important factor in perceptual quality. Therefore, it is necessary to use information of chronologically adjacent images.

Generally, in the case of restoring video degradation using a DNN, a plurality of chronologically consecutive images is input and one degradation-restored image is output. Matias Tassano, Julie Delon, and Thomas Veit, “DVDnet: A Fast Network for Deep Video Denoising”, 2019 IEEE/CVF Conference on Computer Vision and Pattern Recognition (CVPR) discloses a method of performing noise reduction in the spatial direction on N (N is a natural number) chronologically consecutive images, aligning the results, performing noise reduction processing in the temporal direction, and outputting the noise-reduced result of the central one among the N images. In addition, Matias Tassano, Julie Delon, and Thomas Veit, “FastDVDnet: Towards Real-Time Deep Video Denoising Without Flow Estimation”, 2020 IEEE/CVF Conference on Computer Vision and Pattern Recognition (CVPR) discloses a method for omitting the alignment, which is performed after noise reduction in the spatial direction, by incorporating a motion compensation mechanism for performing the alignment into a DNN.

### SUMMARY

Some embodiments of the present disclosure provide an information processing apparatus including one or more memories and one or more processors. The one or more processors and the one or more memories are configured to acquire a plurality of items of input image data, and output, based on N (N is an integer greater than or equal to 2) items of input image data among the plurality of items of input image data, N items of first image data corresponding to the N items of input image data, processed using a neural network.

Further features of various embodiments will become apparent from the following description of exemplary embodiments with reference to the attached drawings.

### BRIEF DESCRIPTION OF THE DRAWINGS

FIG. 1 is a diagram illustrating an example of the configuration of an information processing system.

FIG. 2 is a diagram illustrating an example of the functional configuration of an information processing system according to a first embodiment.

FIG. 3 is a diagram illustrating a degradation restoration inference process according to the first embodiment.

FIG. 4 is a diagram illustrating the structure of a convolutional neural network (CNN) and the flow of inference and training.

FIG. 5 is a diagram illustrating a process of applying degradation to image data.

FIG. 6 is a diagram illustrating a degradation restoration training process.

FIGS. 7A and 7B are flowcharts illustrating an example of processing in the information processing system according to the first embodiment.

FIGS. 8A and 8B are diagrams illustrating the structure of a CNN.

FIG. 9 is a diagram illustrating an example of the functional configuration of an information processing system according to a second embodiment.

FIG. 10 is a diagram illustrating a degradation restoration inference process according to the second embodiment.

FIG. 11 is a flowchart illustrating an example of processing in the information processing system according to the second embodiment.

FIG. 12 is a diagram illustrating an example of the functional configuration of an information processing system according to a third embodiment.

FIG. 13 is a diagram illustrating a degradation restoration inference process according to the third embodiment.

FIGS. 14A and 14B are flowcharts illustrating an example of processing in the information processing system according to the third embodiment.

FIG. 15 is a diagram illustrating an example of the functional configuration of an information processing system according to a fourth embodiment.

FIGS. 16A and 16B are flowcharts illustrating an example of processing in the information processing system according to the fourth embodiment.

### DESCRIPTION OF THE EMBODIMENTS

Conventional video degradation restoration methods involve costly calculations. This is because the process of inputting N chronologically consecutive images and outputting the noise-reduced result of the central one among the N images is performed, while shifting one image at a time in the temporal direction. Hereinafter, embodiments of the present disclosure will be described with reference to the drawings. Note that the following embodiments are not intended to limit every embodiment of the present disclosure, and not all of the combinations of features described in the present embodiments are essential to the solution of every embodiment of the present disclosure. The configuration of the embodiments may be modified or changed as appropriate depending on the specifications and various conditions (usage conditions, usage environment, etc.) of an apparatus to which the embodiments are applied. Also, the embodiments described below may be configured by combining portions of the embodiments as appropriate. In the following embodiments, identical configurations are denoted by the same reference numerals.

### About CNN

First, convolutional neural networks (CNNs) used in general information processing techniques to which deep learning is applied, which are used in the following embodiments, will be described. CNNs are techniques that perform repeated non-linear operations after convolving a filter generated by training or learning over image data. The filter is also referred to as a local receptive field. Image data obtained by convolving the filter over image data and then performing non-linear operations is called a feature map. Also, training or leaning is performed using training data (training images or data sets) composed of pairs of input image data and output image data. Simply, training or learning is to generate, from the training data, the value of a filter that can convert input image data to corresponding output image data with high accuracy.

If image data has RGB color channels or if a feature map is composed of multiple items of image data, a filter used for the convolution also has multiple channels accordingly. That is, the convolutional filter is represented by a four-dimensional array that includes dimensions for height and width and the number of items of data, in addition to the number of channels. The process of performing non-linear operations after convolving the filter over image data (or the feature map) is represented in units of layers, and is expressed, for example, as the feature map of the n-th layer or the filter of the n-th layer. Furthermore, for example, a CNN that repeats the convolution of the filter and the non-linear operation three times has a network structure with three layers. Such non-linear operation processing can be described by the following equation (1):

Xₙ^{(l)}=f(Σₖ₌₁^{K}Wₙ^{(l)*}Xₙ₋₁^{(l)}+bₙ^{(l)}) (1)

In equation (1), Wₙ is the filter of the n-th layer, bₙ is the bias of the n-th layer, f is the non-linear operator, Xₙ is the feature map of the n-th layer, and * is the convolution operator. Note that the right superscript (1) indicates that it is the 1-th filter or feature map. Filters and biases are generated by training described later and are also collectively referred to as “network parameters”. As the non-linear operation, for example, a sigmoid function or ReLU (rectified linear unit) is used. In the case of ReLU, it is described by the following equation (2):

$$f ( X ) = \{ \begin{matrix}X if 0 \leq X \\ 0 otherwise\end{matrix} \qquad ( 2 )$$

As equation (2) indicates, among elements of the input vector X, the negative ones become zero, and the positive ones remain unchanged.

As networks using CNNs, a Residual Neural Network (a.k.a. Residual Network, ResNet) in the field of image recognition and its application Super-Resolution Convolutional Neural Network (SRCNN) in the field of super-resolution are well known. Both architectures utilize CNNs with multiple layers, performing convolutional filtering many times to enhance processing accuracy. For example, ResNet is distinguished by its network structure with a path to shortcut convolutional layers, realizing a multilayer network of as many as 152 layers to achieve highly accurate recognition approaching the recognition rate of humans. The reason why CNNs with multiple layers make processing more accurate is simply that a non-linear relationship between input and output can be represented by performing non-linear operations many times.

### CNN Training

Next, CNN training will be described. CNN training is performed by minimizing an objective function, generally described by the following equation (3), for training data consisting of pairs of input training image (student image) data and corresponding output training image (teacher image) data:

$$L ( θ ) = \frac{1}{n} {\sum }_{i = 1}^{n} {‖ F ( {X}_{i} ; θ ) - {Y}_{i} ‖}_{2}^{2} \qquad ( 3 )$$

In equation (3), L is a loss function that measures the error between the ground truth and its estimation. In addition, Yᵢ is the i-th output training image data, and Xᵢ is the i-th input training image data. In addition, F is a function that collectively represents the operations (equation (1)) performed on each layer of the CNN. Also, θ denotes network parameters (filters and biases). In addition, ∥Z∥₂ is the L2 norm, which is simply the square root of the square sum of the elements of vector Z. In addition, n is the total number of items of training data used for training. In general, the total number of items of training data is large, and hence, in the Stochastic Gradient Descent (SGD) method, a part of the training image data is randomly selected and used for training. This reduces the computational load in training using a lot of training data. Moreover, various methods are known as the objective function minimization (=optimization) method, such as the momentum method, the AdaGrad method, the AdaDelta method, and the Adam method. The Adam method is given by the following equations (4):

$$g = \frac{\partial L}{\partial {θ}_{i}^{t}} \qquad ( 4 )$$

$$m = {β}_{1} m + ( 1 - {β}_{1} ) g$$

$$v = {β}_{2} v + ( 1 - {β}_{2} ) {g}^{2}$$

$${θ}_{i}^{t + 1} = {θ}_{i}^{t} - α \frac{\sqrt{1 - {β}_{2}^{t}}}{( 1 - {β}_{1} )} \frac{m}{( \sqrt{v} + ε )}$$

In equations (4), θᵢ^{t} is the i-th network parameter at the t-th iteration, and g is the gradient of the loss function L for θᵢ^{t}. In addition, m and v are moment vectors, α is the base learning rate, β₁ and β₂ are hyperparameters, and ϵ is a small constant. Since there is no selection guideline for optimization methods in training, basically anything can be used; however, since the convergence of each method is different, it is known that a difference in learning time occurs.

In each of the embodiments described below, it is assumed that information processing (image processing) to reduce video degradation using the above-described CNN on an image-by-image basis is performed. Image degradation factors include, for example, degradation such as noise, blur, aberration, compression, low resolution, and defects, and degradation such as contrast reduction due to the influence of weather such as fog, haze, snow, rain, etc. at the time of shooting, and the like. Image processing to reduce the degradation of images includes noise reduction, blur removal, aberration correction, defect correction, correction of degradation caused by compression, super-resolution processing for low-resolution images, and processing to correct the contrast reduction caused by weather at the time of shooting. Processing to reduce image degradation in each of the embodiments described below is processing of generating or restoring an image with no (or very little) degradation from a degraded image, which is also referred to as a degradation restoration process in the following description. That is, degradation restoration includes, for example, restoring an image that was not (or little) degraded in the image itself, but was degraded by subsequent amplification, compression and decompression, or other image processing, as well as making it possible to reduce degradation included in the original image itself.

### First Embodiment

In a first embodiment, a method of quickly restoring degradation of a video using a neural network that inputs N (N is an integer greater than or equal to 2) items of highly correlated degraded image data and outputs N items of degradation-restored image data will be described. In the present embodiment, noise serves as an example of an image degradation factor, and an example in which a noise reduction process is performed as a degradation restoration process will be described.

### System Configuration

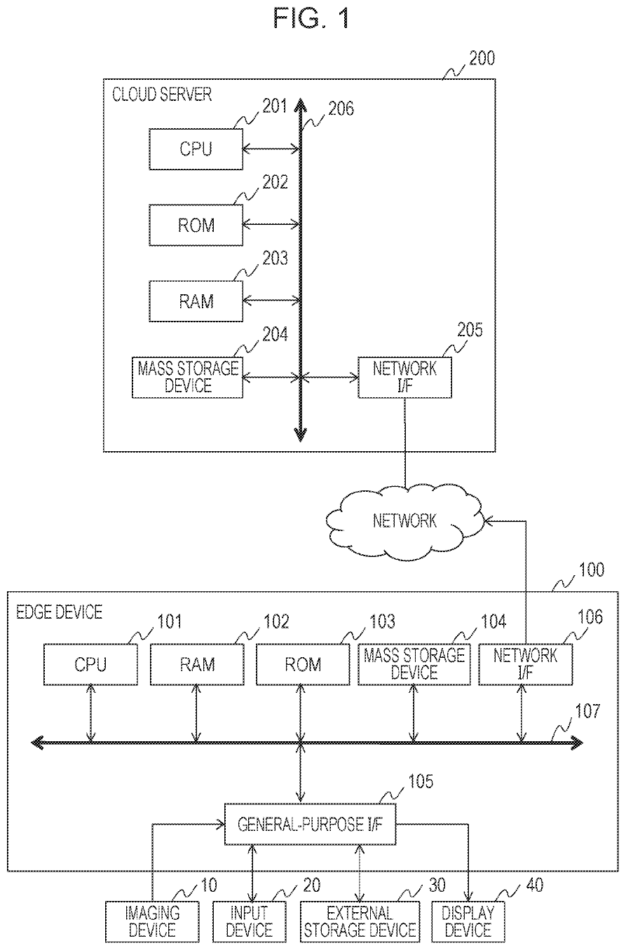

FIG. 1 is a block diagram illustrating an example of the configuration of an information processing system according to the present embodiment. In the information processing system illustrated in FIG. 1, a cloud server 200 responsible for training to generate training data and to restore degradation (hereinafter also referred to as degradation restoration training) and an edge device 100 responsible for degradation restoration (hereinafter also referred to as degradation restoration inference) are connected via a network.

### Hardware Configuration of Edge Device

The edge device 100 of the present embodiment acquires raw image data (Bayer arrangement) input from an imaging device 10 as an input image, which is to be subjected to a degradation restoration process. The edge device 100 then applies learned network parameters provided by the cloud server 200 to the input image subjected to a degradation restoration process to make a degradation restoration inference. That is, the edge device 100 is an information processing apparatus that reduces noise in raw image data by executing a pre-installed information processing application program using a neural network provided by the cloud server 200. The edge device 100 has a central processing unit (CPU) 101, a random-access memory (RAM) 102, a read-only memory (ROM) 103, a mass storage device 104, a general-purpose interface (I/F) 105, and a network I/F 106, and these components are interconnected by a system bus 107. The edge device 100 is also connected to the imaging device 10, an input device 20, an external storage device 30, and a display device 40 via the general-purpose I/F 105.

The CPU 101 executes programs stored in the ROM 103 using the RAM 102 as a work memory to collectively control the components of the edge device 100 via the system bus 107. The mass storage device 104 is a hard disk drive (HDD) or a solid state drive (SSD), for example, and stores various types of data handled by the edge device 100. The CPU 101 writes data to the mass storage device 104 and reads out data stored in the mass storage device 104 via the system bus 107. The general-purpose I/F 105 is a serial bus interface such as, for example, Universal Serial Bus (USB), Institute of Electrical and Electronics Engineers (IEEE) 1394, High-Definition Multimedia Interface (HDMI®), or the like. The edge device 100 acquires data from the external storage device 30 (various storage media such as a memory card, CompactFlash (CF) card, Secure Digital (SD) card, USB memory, etc.) via the general-purpose I/F 105. In addition, the edge device 100 accepts user instructions from the input device 20, such as a mouse and a keyboard, via the general-purpose I/F 105. The edge device 100 also outputs image data processed by the CPU 101 to the display device 40 (various image display devices such as a liquid crystal display) via the general-purpose I/F 105. Moreover, the edge device 100 acquires data of a captured image (raw image), which is to be subjected to a degradation restoration process (noise reduction process in this example), from the imaging device 10 via the general-purpose I/F 105. The network I/F 106 is an interface for connecting to a network such as the Internet. The edge device 100 accesses the cloud server 200 using an installed web browser to acquire network parameters for degradation restoration inference.

### Hardware Configuration of Cloud Server

The cloud server 200 of the present embodiment is an information processing apparatus that provides cloud services over a network, such as the Internet. The cloud server 200 performs the generation of training data and degradation restoration training, and generates a trained model that stores network parameters and a network structure that are the training results. The cloud server 200 then provides the trained model in response to a request from the edge device 100. The cloud server 200 has a CPU 201, a ROM 202, a RAM 203, a mass storage device 204, and a network I/F 205, and these components are interconnected by a system bus 206.

The CPU 201 controls the overall operation by reading out control programs stored in the ROM 202 and performing various processes. The RAM 203 is used by the CPU 201 as the main memory as well as a temporary storage area, such as a work area. The mass storage device 204 is a large-capacity secondary storage device, such as an HDD or an SSD, storing image data and various programs. The network I/F 205 is an interface for connecting to a network, such as the Internet, and provides the above-mentioned network parameters in response to a request from the web browser of the edge device 100.

Note that the components of the edge device 100 and the cloud server 200 include configurations other than those mentioned above, but their descriptions will be omitted here. In the present embodiment, it is assumed that the cloud server 200 downloads the trained model, which is the result of generating training data and performing degradation restoration training, to the edge device 100, and the edge device 100 performs degradation restoration inference over the input image data being processed. Note that the above-mentioned system configuration is an example and is not the only possible configuration. For example, the functions performed by the cloud server 200 may be subdivided, and the generation of training data and degradation restoration training may be executed on separate devices. Alternatively, the imaging device 10, which combines the functions of the edge device 100 and the functions of the cloud server 200, may be configured to perform all of the following: generation of training data, degradation restoration training, and degradation restoration inference.

### Functional Configuration of System

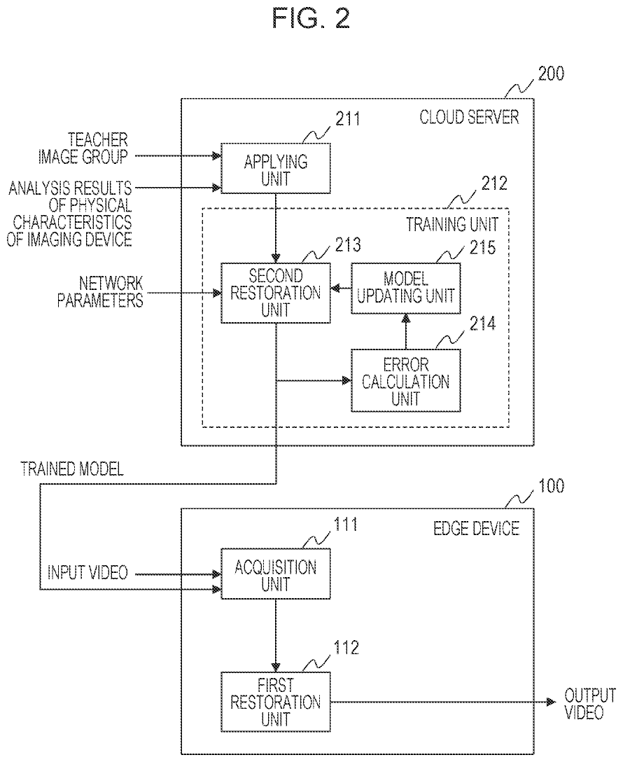

Referring next to FIG. 2, the functional configuration of the information processing system according to the first embodiment will be described. FIG. 2 is a block diagram illustrating an example of the functional configuration of the information processing system according to the first embodiment.

As illustrated in FIG. 2, the edge device 100 has an acquisition unit 111 and a first restoration unit 112. In addition, the cloud server 200 has an applying unit 211 and a training unit 212. The training unit 212 has a second restoration unit 213, an error calculation unit 214, and a model updating unit 215.

Each functional unit illustrated in FIG. 2 is realized, for example, by the CPU 101 or the CPU 201 executing a computer program for realizing each function. Note that all or some of the functional units illustrated in FIG. 2 may be implemented in hardware.

Note that the configuration illustrated in FIG. 2 can be modified or changed as appropriate. For example, one functional unit may be divided into multiple functional units, or two or more functional units may be integrated into one functional unit. Also, the configuration illustrated in FIG. 2 may be implemented by two or more devices. In this case, the devices are connected via a circuit or a wired or wireless network, and perform cooperative operations by communicating data with each other to realize each process according to the present embodiment.

Each functional unit of the edge device 100 will be described.

The acquisition unit 111 acquires input video data to be processed and selects N (N is an integer greater than or equal to 2) items of highly correlated input image data. The acquisition unit 111 corresponds to an example of a first acquisition unit and a second acquisition unit. It is described here that highly correlated items of data are chronologically consecutive items of data. The value of N may be a preset value, or any value set by the user may be used. In the present embodiment, it is assumed that N=3, and as input image data, raw image data in which each pixel has a pixel value corresponding to one of the RGB colors is used. The raw image data is assumed to be image data captured using color filters with the Bayer arrangement in which each pixel has information of one color.

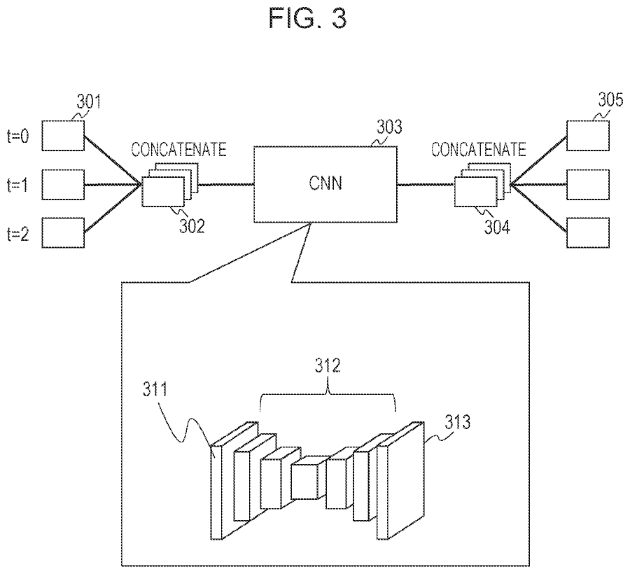

The first restoration unit 112 is a degradation restoration unit for inference, which makes a degradation restoration inference for every N items of input image data using a trained model acquired from the cloud server 200 and outputs output video data. FIG. 3 is a diagram illustrating an overview of a degradation restoration process performed by the first restoration unit 112 according to the present embodiment.

The first restoration unit 112 concatenates items of input image data 301 at times t=0, 1, and 2 in a channel direction to generate input concatenated image data 302. Here, the channel direction refers to a direction in which pixels at the same coordinates of multiple items of input image data are overlaid (stacked), and this direction is orthogonal to each of the height and width of the input image data. Since the number of channels of the raw image data is one, if the height of the input image data is denoted as H and the width as W, the input concatenated image data 302 obtained by concatenating three items of input image data 301 has a data structure of H×W×3.

Next, the first restoration unit 112 inputs the input concatenated image data 302 to a CNN 303, repeatedly performs the convolution operations of filters and the non-linear operations described by equations (1) and (2), and outputs output concatenated image data 304 in which the degradation is restored. The output concatenated image data 304 has the same shape as the input concatenated image data 302, and the corresponding channels in both items of data are at the same time. The channels are not in a particular order, and there is no problem as long as there is a temporal correlation between the input concatenated image data 302 and the output concatenated image data 304.

As illustrated in FIG. 3, the CNN 303 has an input layer 311, hidden layers 312 consisting of a plurality of layers, and an output layer 313. As mentioned above, the input layer 311 and the output layer 313 have the same shape. In the present embodiment, the hidden layers 312 are smaller in size (height and width) and have a greater number of channels than the input and output layers (input layer 311 and output layer 313). This is generally a technique for obtaining a wide range of information in an image and enhancing expressiveness.

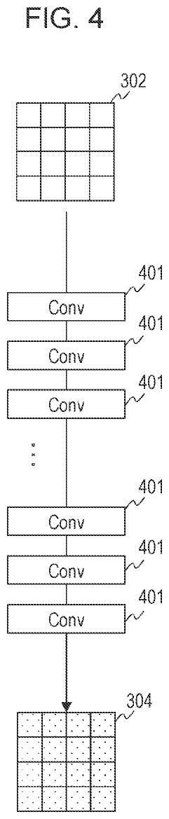

FIG. 4 is a diagram illustrating the structure of a CNN and the flow of inference and training. Hereinafter, the CNN will be described with reference to FIG. 4. The CNN is composed of a plurality of filters 401 that perform the operations described in equation (1) mentioned above. First, the first restoration unit 112 inputs the input concatenated image data 302 to this CNN. The first restoration unit 112 then sequentially applies the filters 401 to the input concatenated image data 302 to calculate a feature map (not illustrated). Then, the first restoration unit 112 takes the restoration result obtained by applying the last filter 401 as the output concatenated image data 304.

The first restoration unit 112 performs the reverse operations from the concatenation of the input image data 301 on the output concatenated image data 304 to obtain items of degradation-restored image data at times t=0, 1, and 2. Finally, the first restoration unit 112 outputs output video data 305 with these items of image data that are sequentially numbered.

Next, each functional unit of the cloud server 200 will be described.

The applying unit 211 applies at least one or more degradation factors to teacher image data extracted from a group of non-degraded teacher images to generate student image data. Since noise is mentioned as an example of a degradation factor in this example, the applying unit 211 applies noise as a degradation factor to teacher image data to generate student image data. In the present embodiment, the applying unit 211 analyzes the physical characteristics of the imaging device and, based on the analysis results, applies noise, as a degradation factor, corresponding to a degradation amount in a wider range than the degradation amount that may occur in the imaging device to teacher image data, thereby generating student image data. The reason for applying a degradation amount in a wider range than the analysis results is that, because the range of the degradation amount differs depending on the differences of the individual imaging devices, robustness is increased by providing a margin.

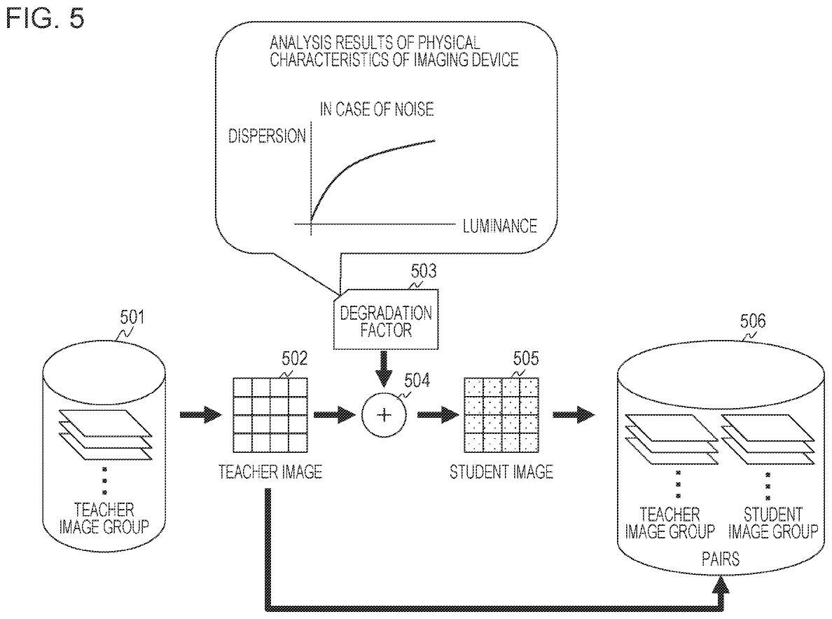

That is, as illustrated in FIG. 5, the applying unit 211 applies (504) noise, as a degradation factor 503, based on the analysis results of the physical characteristics of the imaging device, to teacher image data 502 extracted from a teacher image group 501, thereby generating student image data 505. Then, the applying unit 211 pairs the teacher image data 502 and the student image data 505 as training data. The applying unit 211 generates a student image group consisting of multiple items of student image data by applying a degradation factor to each item of teacher image data of the teacher image group 501, thereby generating training data 506.

Although noise is mentioned as an example of a degradation factor in this example, the applying unit 211 may apply any one or more of multiple types of degradation factors, such as the above-mentioned blur, aberration, compression, low resolution, defects, contrast reduction due to the influence of weather at the time of shooting, or a combination of these, to the teacher image data.

The teacher image group contains various types of image data, such as photographs of nature including landscapes or animals; photographs of people, such as portraits or sports photographs; and photographs of artifacts, such as buildings or products. In the present embodiment, it is assumed that the teacher image data, like the input image data, is raw image data in which each pixel has a pixel value corresponding to one of the RGB colors. In addition, the analysis results of the physical characteristics of the imaging device include, for example, the amount of noise per sensitivity caused by the imaging sensor built into the camera (imaging device), the amount of aberration caused by the lens, and the like. By using these, it is possible to estimate how much image quality degradation occurs under each shooting condition.

In other words, by applying degradation estimated under certain shooting conditions to the teacher image data, an image equivalent to that obtained at the time of shooting can be generated.

The training unit 212 acquires network parameters to be applied to the CNN for degradation restoration training, initializes the weights of the CNN using the acquired network parameters, and then performs degradation restoration training using the training data generated by the applying unit 211. The network parameters include the initial values of the parameters of the neural network, and hyperparameters indicating the structure and optimization method of the neural network. The degradation restoration training in the training unit 212 is performed by the second restoration unit 213, the error calculation unit 214, and the model updating unit 215.

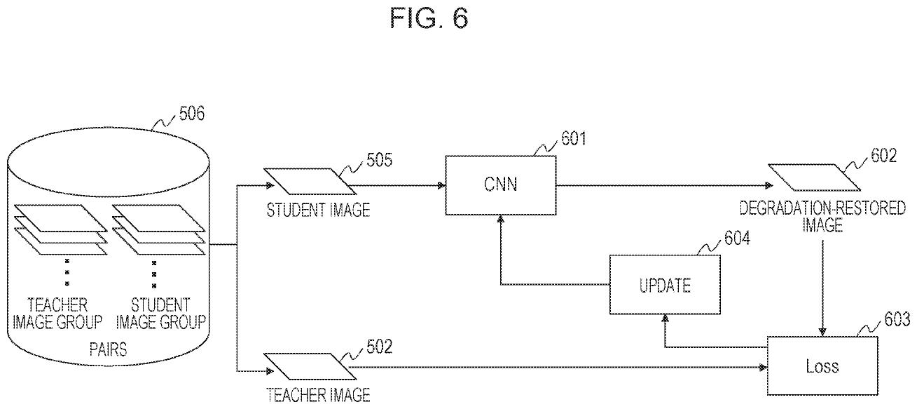

FIG. 6 is a diagram illustrating the processing of degradation restoration training in the training unit 212.

The second restoration unit 213 is a degradation restoration unit for training, which receives the training data 506 from the applying unit 211 and restores the degradation of the student image data 505. Specifically, the second restoration unit 213 inputs the student image data 505 to a CNN 601, repeatedly performs the convolution operations of filters and the non-linear operations described by equations (1) and (2), and outputs degradation-restored image data 602.

The error calculation unit 214 inputs the teacher image data 502 and the degradation-restored image data 602 to a loss 603 to calculate the error between the two. Here, the teacher image data 502 and the degradation-restored image data 602 have the same number of pixels. The model updating unit 215 inputs the error calculated by the error calculation unit 214 to an updating process 604 to update the network parameters for the CNN 601 so as to reduce the error. Note that the CNN used in the training unit 212 is the same neural network as the CNN used in the first restoration unit 112.

### Flow of Processing of Overall System

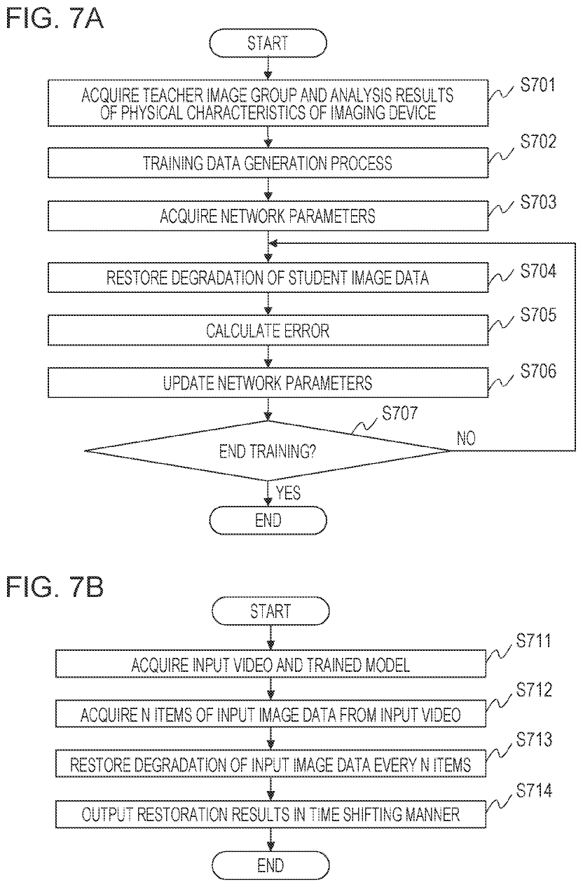

Next, various processes performed in the information processing system according to the first embodiment will be described. FIGS. 7A and 7B are flowcharts illustrating examples of processing in the information processing system according to the first embodiment. The following description follows the flowcharts of FIGS. 7A and 7B.

Referring to the flowchart of FIG. 7A, the flow of an example of degradation restoration training performed by the cloud server 200 will be described.

In step S701, the cloud server 200 acquires a teacher image group prepared in advance and the analysis results of the physical characteristics of the imaging device, such as the characteristics of the imaging sensor, the sensitivity at the time of shooting, the object distance, the focal length and the f value of the lens, the exposure value, and the like. Teacher image data of the teacher image group is raw image data with the Bayer arrangement, and is obtained by capturing an image with the imaging device 10, for example. This is not the only possible case, and images captured by the imaging device 10 may be uploaded as they are to the cloud server 200 as teacher image data, or captured images may be stored in the HDD or the like and uploaded as teacher image data. The data of the teacher image group and the analysis results of the physical characteristics of the imaging device, which are acquired by the cloud server 200, are sent to the applying unit 211.

In step S702, the applying unit 211 performs a training data generation process, and applies noise to the teacher image data of the teacher image group acquired in step S701 based on the analysis results of the physical characteristics of the imaging device to generate student image data. The applying unit 211 applies a degradation factor to each item of teacher image data of the teacher image group to generate a plurality of items of student image data, and pairs the teacher image data and the student image data as training data. Note that the applying unit 211 applies noise whose amount is measured in advance based on the analysis results of the physical characteristics of the imaging device in a preset order or in a random order.

In step S703, the cloud server 200 acquires network parameters to be applied to the CNN for degradation restoration training. The network parameters here include the initial values of the parameters of the neural network, and the hyperparameters indicating the structure and optimization method of the neural network, as described above. The network parameters acquired by the cloud server 200 are sent to the training unit 212.

In step S704, the second restoration unit 213 of the training unit 212 initializes the weights of the CNN using the network parameters acquired in step S703, and then performs degradation restoration of the student image data generated in step S702. As described above, the second restoration unit 213 inputs the student image data to the CNN, performs degradation restoration of the student image data by repeatedly performing the convolution operations of filters and the non-linear operations described by equations (1) and (2), and outputs degradation-restored image data.

In step S705, the error calculation unit 214 of the training unit 212 calculates the error between the teacher image data and the degradation-restored image data, which is obtained by degradation restoration in step S704, according to the loss function described in equation (3).

In step S706, the model updating unit 215 of the training unit 212 updates the network parameters for the CNN so as to reduce (minimize) the error obtained in step S705, as described above.

In step S707, the training unit 212 determines whether to end the training. The training unit 212 determines to end the training, for example, if the number of updates of the network parameters reaches a certain count. If the training unit 212 determines to end the training (YES in step S707), the degradation restoration training illustrated in FIG. 7A ends. If the training unit 212 determines not to end the training (NO in step S707), the processing of the cloud server 200 returns to step S704, and, with the processing from step S704 onward, training using another item of student image data and another item of teacher image data is performed.

Referring next to the flowchart of FIG. 7B, the flow of an example of a degradation restoration inference made by the edge device 100 will be described.

In step S711, the edge device 100 acquires the trained model, which is the training result of degradation restoration training by the cloud server 200, along with input video data subjected to a degradation restoration process. As the input video data, for example, what was captured by the imaging device 10 may be directly input, or what was captured in advance and stored in the mass storage device 104 may be read out. The input video data and the trained model acquired by the edge device 100 are sent to the acquisition unit 111.

In step S712, the acquisition unit 111 selects N items of input image data from the input video data acquired in step S711 and generates input concatenated image data concatenated in the channel direction. In the present embodiment, the acquisition unit 111 selects and acquires N chronologically consecutive items of input image data from the input video data.

In step S713, the first restoration unit 112 constructs the same CNN as that used in the training of the training unit 212 and performs degradation restoration of the input concatenated image data. At this time, the existing network parameters are initialized by the updated network parameters acquired from the cloud server 200 in step S711. In this way, the first restoration unit 112 inputs the input concatenated image data to the CNN to which the updated network parameters have been applied, performs degradation restoration in the same manner as performed by the training unit 212, and obtains output concatenated image data.

In step S714, the first restoration unit 112 divides the output concatenated image data obtained in step S713 into N items, obtains N items of degradation-restored image data corresponding to the times of the input image data, and outputs them as an output video.

The description so far is the overall flow of processing performed in the information processing system according to the first embodiment.

In conventional video degradation restoration processing, the process of inputting N chronologically consecutive degraded images and outputting one degradation-restored image has been applied while shifting one image at a time in the temporal direction. At this time, if the total number of items of input image data constituting the input video data is denoted as K (where K is an integer satisfying N≤K) and the amount to be shifted as M (where M is an integer satisfying 1≤M≤N), the number of degradation restoration process iterations, denoted as F, is calculated as F=K−2×(N/2) (*the division result is rounded down). That is, if K=90, N=3, M=1, then F=88.

In the meantime, as in the present embodiment, by performing the process of inputting N degraded images and outputting N degradation-restored images while shifting N images at a time in the temporal direction, the number of degradation restoration process iterations can be reduced to F=K/N. That is, in the present embodiment, if K=90 and N=3, then F=30. In other words, the total time required for the degradation restoration process is approximately 1/(N−1) to 1/N, which means that the processing time of degradation restoration per degradation-restored image can be reduced and the acceleration of the video degradation restoration process can be realized.

Although the training data is generated in step S702 of FIG. 7A, the training data may be generated later. For example, it may be configured to generate student image data corresponding to teacher image data in subsequent degradation restoration training. Also, in the present embodiment, training is performed from scratch using the data of a teacher image group prepared in advance, but the degradation restoration training process in the present embodiment may be performed based on pre-learned network parameters.

Although raw image data captured with color filters with the Bayer arrangement has been described as an example in the present embodiment, raw image data captured with other color filter arrangements may be used. Moreover, raw image data has one channel, but the pixels may be sorted in the order of R, G1, G2, and B in the color filter arrangement. At this time, the data structure is H×W×4, and if N=3, concatenating the raw image data results in the data structure of H×W×12. Also, the image data format is not limited to a raw image, and may be, for example, a demosaiced RGB image or an image converted to the YUV format.

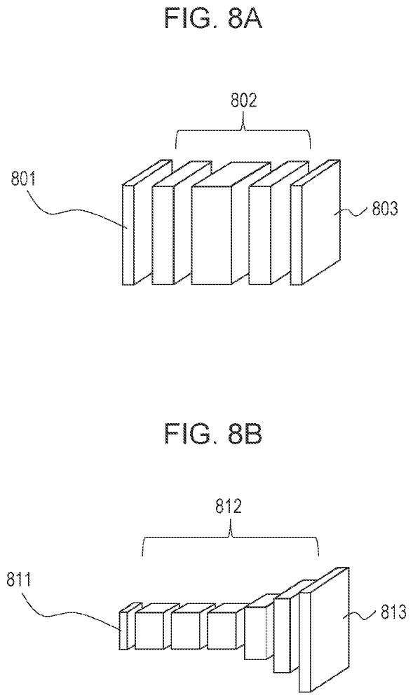

Although the CNN where the height and width of the hidden layers are smaller than those of the input/output layers as illustrated in FIG. 3 has been described in the present embodiment, the structure of the CNN is not limited thereto. For example, as illustrated in FIG. 8A, the height and width of an input layer 801 and an output layer 803 may be equal to the height and width of hidden layers 802.

Although noise as a degradation factor has been described as an example in the present embodiment, the degradation factor is not limited thereto. Degradation factors may include any of the above-mentioned degradation such as blur, aberration, compression, low resolution, defects, contrast reduction due to and the influence of fog, haze, snow, rain, etc. at the time of shooting, or a combination of these. In that case, the size and the number of channels of the input/output layers of the CNN differ depending on the degradation factor. For example, in the case of super-resolution, the number of channels is equal in the input image data and the output image data, but the height and width of the output image data are larger than those of the input image data. An example of a CNN in this case is illustrated in FIG. 8B. As illustrated in FIG. 8B, there is a plurality of hidden layers 812 between an input layer 811 and an output layer 813, and the height and width of the output layer 813 are larger than the height and width of the input layer 811. In addition, in the case of generating a color image from an image in which color information has been lost, the size of the input image data and the size of the output image data are equal, but the number of channels is greater in the output image data than in the input image data.

### Second Embodiment

In the first embodiment, an example in which a video degradation restoration process is performed at a high speed by using a neural network that receives N items of degraded image data as input and outputs N items of degradation-restored image data has been described. In the first embodiment, although the acceleration of a video degradation restoration process can be realized, the degradation-restored video data remains fluctuating (or flickering) in the temporal direction. This is because the continuity in the temporal direction decreases or disappears in the switching of sets of N images when performing processing in units of sets while shifting N images at a time in the temporal direction. This fluctuation becomes noticeable when the degree of degradation is large.

A second embodiment describes a method of eliminating or reducing temporal discontinuities by performing a degradation restoration process that inputs N items of degraded image data while shifting each set of N images to overlap, and outputs N items of degradation-restored image data, and combining the obtained restoration results at the same time. Note that descriptions of details common to the first embodiment, such as the basic configuration of the information processing system, will be omitted, and different points will be mainly described.

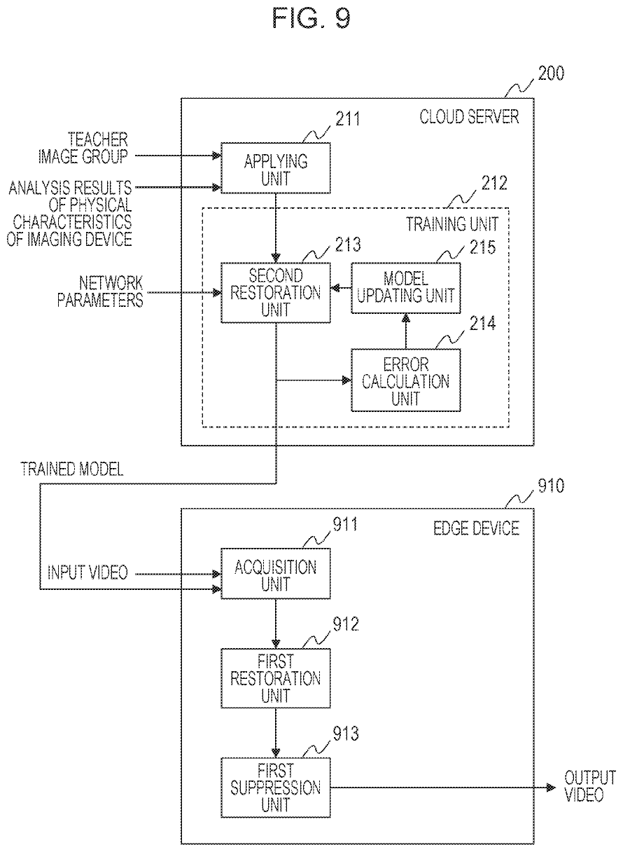

FIG. 9 is a block diagram illustrating an example of the functional configuration of an information processing system according to the second embodiment. In FIG. 9, components having the same functions as the components illustrated in FIG. 2 are given the same reference numerals, and overlapping descriptions are omitted. As illustrated in FIG. 9, an edge device 910 according to the second embodiment has an acquisition unit 911, a first restoration unit 912, and a first suppression unit 913. Note that the cloud server 200 according to the second embodiment is the same as or similar to the cloud server 200 according to the first embodiment. Each functional unit illustrated in FIG. 9 is realized, for example, by the CPU 101 or the CPU 201 executing a computer program for realizing each function. Note that all or some of the functional units illustrated in FIG. 9 may be implemented in hardware.

The edge device 910 will be described.

The acquisition unit 911 acquires N chronologically consecutive items of input image data from input video data to be processed. In the present embodiment, as in the first embodiment, a degradation restoration process is performed on each set of N items of input image data, but the present embodiment is different from the first embodiment in the point that N items of input image data are selected so as to have a partial overlap between the sets. If the amount to be shifted in the temporal direction is denoted as M, M=N is set in the first embodiment to avoid overlap, but in the present embodiment, 1≤M≤N is set to select items of data while shifting them in the temporal direction within a range of 1 to N items.

The first restoration unit 912 is a degradation restoration unit for inference, which performs a degradation restoring process as in the first embodiment on N items of input image data selected by the acquisition unit 911. That is, the first restoration unit 112 uses the trained model acquired from the cloud server 200 to make degradation restoration inferences for N items of input image data. Since each set has been selected to contain N items of input image data with a partial overlap, multiple items of degradation-restored image data at the same time are output from the first restoration unit 912.

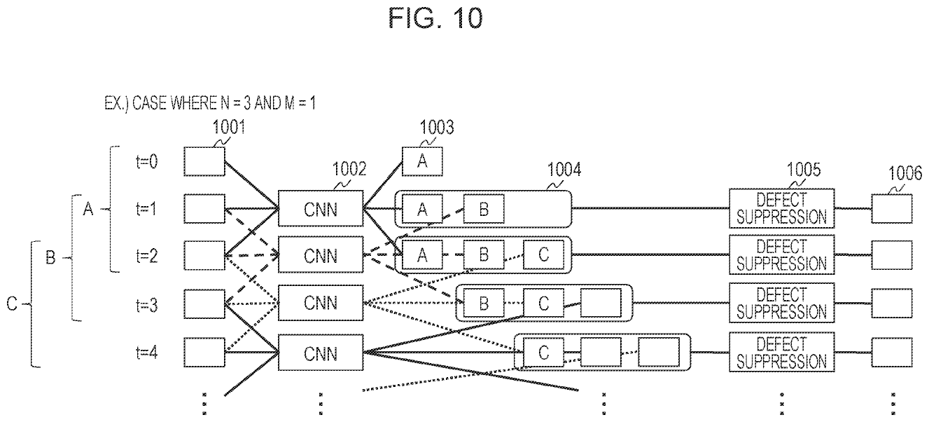

FIG. 10 is a diagram illustrating an overview of a degradation restoration process according to the second embodiment. FIG. 10 illustrates an example of the case where, if N=3 and M=1, a degradation restoration process of inputting three items of degraded image data and outputting three items of degradation-restored image data is performed while shifting one image at a time in the temporal direction.

Let items of input image data at times t=0, 1, and 2 selected in chronological order from input video data 1001 be a set A, items of input image data at times t=1, 2, and 3 be a set B, and items of input image data at times t=2, 3, and 4 be a set C. Next, the first restoration unit 912 concatenates items of input image data in each set in the channel direction, and inputs the obtained input image concatenated data A, B, and C to CNNs 1002 to perform a degradation restoration process. As a result, degradation-restored output image concatenated data is obtained. Then, the first restoration unit 912 divides the output image concatenated data by time and outputs degradation-restored image data 1003 of each of the sets A, B, and C. If N=3, one item of degradation-restored image data 1003 at time t=0 is obtained, two items of degradation-restored image data 1003 at time t=1 are obtained, and, from time t=2 onward, three items of degradation-restored image data 1003 are obtained at each time.

The first suppression unit 913 combines a plurality of items of degradation-restored image data 1004 at the same time and outputs a single item of degradation-restored image data at each time (hereinafter also referred to as a defect suppression process). For example, if N=3, the first suppression unit 913 performs a defect suppression process 1005 on items of degradation-restored image data 1004 at the same time as illustrated in FIG. 10, and the result that the defects (discontinuities in the temporal direction) are suppressed is output as output video data 1006. Note that the maximum number of degradation-restored images at the same time is N, and the first suppression unit 913 will combine N images in the defect suppression process 1005. The combining method includes averaging or weighted averaging in units of pixels in the N degradation-restored images.

### Flow of Processing of Overall System

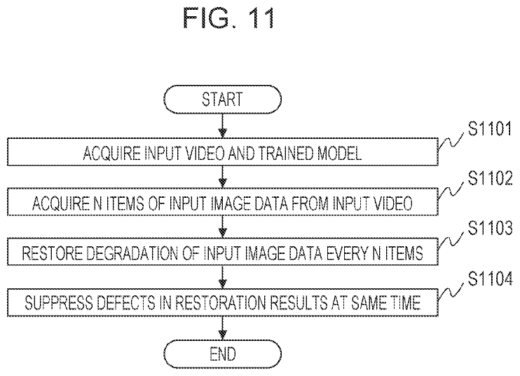

Next, various processes performed in the information processing system according to the second embodiment will be described. FIG. 11 is a flowchart illustrating an example of processing in the information processing system according to the second embodiment.

In the second embodiment, degradation restoration training performed by the cloud server 200 is the same as or similar to that in the first embodiment.

Referring to the flowchart of FIG. 11, the flow of an example of a degradation restoration inference made by the edge device 910 will be described.

In step S1101, the edge device 910 acquires the trained model, which is the training result of degradation restoration training by the cloud server 200, along with input video data subjected to a degradation restoration process. The input video data and the trained model acquired by the edge device 910 are sent to the acquisition unit 911.

In step S1102, the acquisition unit 911 selects N items of input image data from the input video data acquired in step S1101 and generates input concatenated image data concatenated in the channel direction. In the present embodiment, the acquisition unit 911 selects N chronologically consecutive items of input image data from the input video data so as to have a partial overlap between the sets.

In step S1103, the first restoration unit 912 constructs the same CNN as that used in the training of the training unit 212 and performs a degradation restoration process of the input concatenated image data. At this time, the existing network parameters are initialized by the updated network parameters acquired from the cloud server 200 in step S1101. In this way, the first restoration unit 912 inputs the input concatenated image data to the CNN to which the updated network parameters have been applied, performs a degradation restoration process in the same manner as performed by the training unit 212, and obtains output concatenated image data.

Then, the first restoration unit 912 divides the obtained output concatenated image data into items of degradation-restored image data for each time.

In step S1104, the first suppression unit 913 combines items of degradation-restored image data at the same time, obtained by the first restoration unit 912 in step S1103, to obtain a single item of degradation-restored image data whose defects have been suppressed, and outputs it as output video data.

The description so far is the overall flow of processing performed in the information processing system according to the second embodiment.

In the second embodiment, temporal discontinuities are eliminated or reduced by performing a degradation restoration process that inputs N items of degraded image data while shifting each set of N images to overlap, and outputs N items of degradation-restored image data, and combining the obtained restoration results at the same time. This can reduce temporal fluctuation in degradation-restored video data. The present embodiment can obtain an effect that can reduce fluctuation in the case where at least one or more images overlap in each set of N images, and the more the overlapping images, the greater the fluctuation reduction effect. However, the fluctuation reduction effect and the processing speed are in a trade-off relationship, and the greater the fluctuation reduction effect, the slower the processing speed. This trade-off can be adjusted by the shift amount M, and it may be necessary to set the shift amount M to 1<M in order to reduce the fluctuation while processing faster than the conventional N-input 1-output.

In the present embodiment, as the image data combining method performed by the first suppression unit 913, the average value is used as the representative value, but this is not the only possible case. For example, the median value or the most frequent value may be used as the representative value on a pixel-by-pixel basis in N images. Alternatively, a combining method using a neural network, rather than a rule-based combining method, may be used.

### Third Embodiment

In the second embodiment, an example has been described in which temporal discontinuities are eliminated or reduced by performing a degradation restoration process that inputs N items of degraded image data while shifting each set of N images to overlap, and outputs N items of degradation-restored image data, and combining the obtained restoration results at the same time. In the second embodiment, if the degree of degradation of the input video is great (for example, extremely noisy), fluctuation may remain even if a defect suppression process is performed on the degradation-restored images. This residual fluctuation becomes noticeable when N is small, that is, when there are fewer degradation-restored images to be combined.

A third embodiment describes a method of further reducing the residual fluctuation by implementing a set of a degradation restoration process and a defect suppression process in multiple stages. Note that descriptions of details common to the first and second embodiments, such as the basic configuration of the information processing system, will be omitted, and different points will be mainly described.

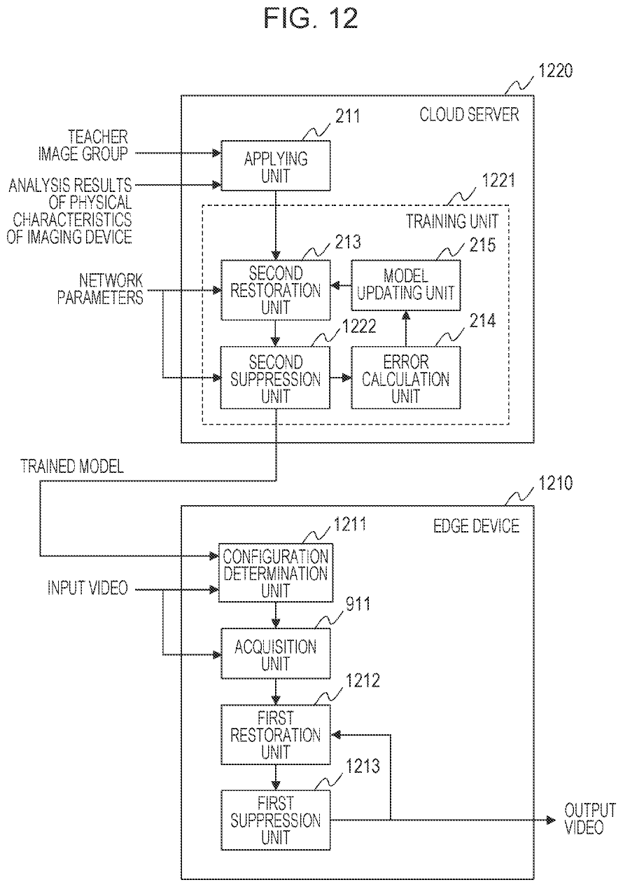

FIG. 12 is a block diagram illustrating an example of the configuration of an information processing system according to the third embodiment.

In FIG. 12, components having the same functions as the components illustrated in FIGS. 2 and 9 are given the same reference numerals, and overlapping descriptions are omitted. As illustrated in FIG. 12, an edge device 1210 according to the third embodiment has a configuration determination unit 1211, the acquisition unit 911, a first restoration unit 1212, and a first suppression unit 1213. Moreover, a cloud server 1220 according to the third embodiment has the applying unit 211 and a training unit 1221. The training unit 1221 has the second restoration unit 213, a second suppression unit 1222, the error calculation unit 214, and the model updating unit 215. Each functional unit illustrated in FIG. 12 is realized, for example, by the CPU 101 or the CPU 201 executing a computer program for realizing each function. Note that all or some of the functional units illustrated in FIG. 12 may be implemented in hardware.

Each functional unit of the edge device 1210 will be described.

For a degradation restoration process and a defect suppression process that are considered as a single set, the configuration determination unit 1211 determines the number of iterations I of the set (where I is an integer satisfying 1≤I). In the present embodiment, I=2 is set as an example. Note that, if I=1, the same processing as that in the second embodiment is performed.

The first restoration unit 1212 is a degradation restoration unit for inference, which performs a process that is the same as or similar to a degradation restoration process performed by the first restoration unit 912 in the second embodiment for I iterations. The first suppression unit 1213 is a defect suppression unit for inference, which performs a process of inputting all of items of degradation-restored image data at the same time output from the first restoration unit 1212 and outputting a single defect-suppression result for I iterations.

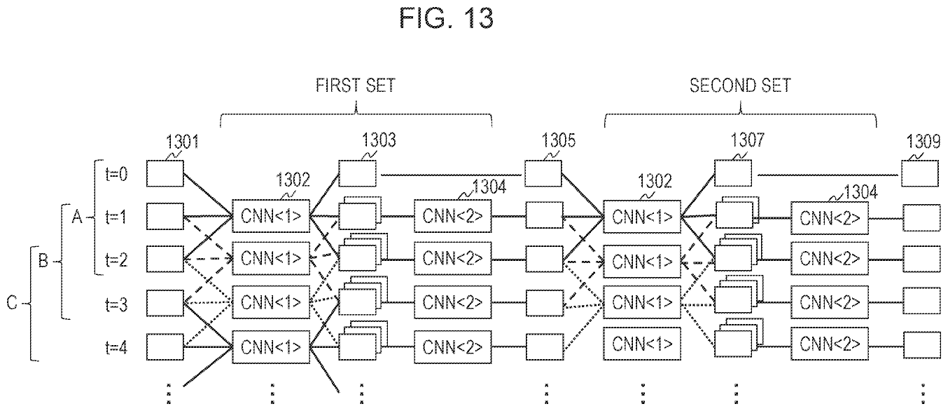

FIG. 13 is a diagram illustrating an overview of a degradation restoration process according to the third embodiment. FIG. 13 illustrates an example of the case of N=3, M=1, and I=2, that is, the case where a degradation restoration process of inputting three items of degraded image data and outputting three items of degradation-restored image data is performed while shifting one item of image data at a time in the temporal direction, and the set of a degradation restoration process and a defect suppression process is performed twice.

In the first set, a degradation restoration process is performed using a corresponding one of CNNs <1> 1302 on N items of input image data selected chronologically from input video data 1301, and a defect suppression process is performed using a corresponding one of CNNs <2> 1304 on a result 1303 of the degradation restoration process. In the second set, sets A, B, and C of N items of data are created again based on output results 1305 of the first set, a degradation restoration process and a defect suppression process are performed using the CNNs <1> 1302 and the CNNs <2> 1304 used in the first set, and the results are output as output video data 1309. In other words, a degradation restoration process is performed using the CNNs <1> 1302 on N items of input image data selected from the output results 1305, and a defect suppression process is performed using the CNNs <2> 1304 on results 1307 of the degradation restoration process.

Next, each functional unit of the cloud server 1220 will be described.

The second suppression unit 1222 is a defect suppression unit for training, which combines items of degradation-restored image data at the same time using a CNN to output a single item of degradation-restored image data. It is assumed that the structure of the CNN in the second suppression unit 1222 is to receive N items of degradation-restored image data as input and output one item of degradation-restored image data.

### Flow of Processing of Overall System

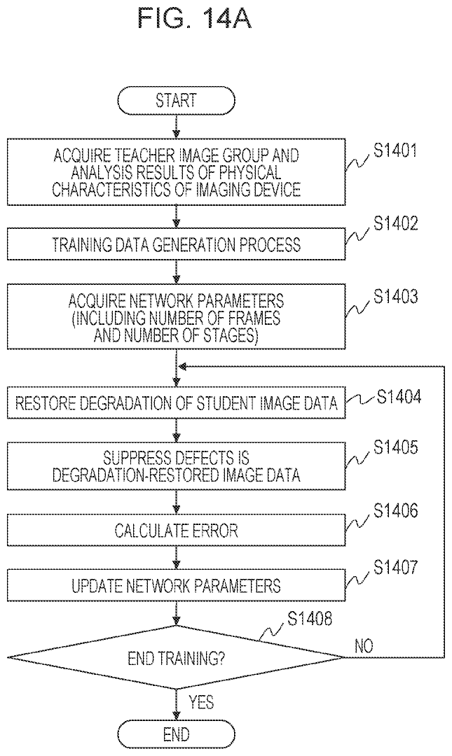

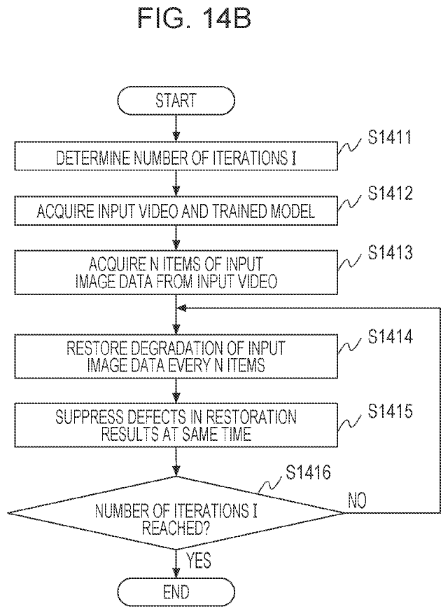

Next, various processes performed in the information processing system according to the third embodiment will be described. FIGS. 14A and 14B are flowcharts illustrating examples of processing in the information processing system according to the third embodiment. The following description follows the flowcharts of FIGS. 14A and 14B.

Referring to the flowchart of FIG. 14A, the flow of an example of degradation restoration training performed by the cloud server 1220 will be described.

In step S1401, the cloud server 1220 acquires, in the manner as in step S701 in the first embodiment, a teacher image group prepared in advance and the analysis results of the physical characteristics of the imaging device. The data of the teacher image group and the analysis results of the physical characteristics of the imaging device, which are acquired by the cloud server 1220, are sent to the applying unit 211.

In step S1402, the applying unit 211 performs a training data generation process in the manner as in step S702 in the first embodiment.

In step S1403, the cloud server 1220 acquires network parameters to be applied to CNNs for degradation restoration training and defect suppression training. The network parameters acquired by the cloud server 1220 are sent to the training unit 1221.

In step S1404, the second restoration unit 213 of the training unit 1221 performs degradation restoration of student image data and outputs degradation-restored image data in the manner as in step S704 in the first embodiment. After initializing the weights of the CNN using the network parameters acquired in step S1403, the second restoration unit 213 performs degradation restoration of the student image data generated in step S1402 and outputs degradation-restored image data.

In step S1405, the second suppression unit 1222 of the training unit 1221 initializes the weights of the CNN using the network parameters acquired in step S1403, and then performs defect suppression of the degradation-restored image data whose degradation has been restored in step S1404.

In step S1406, the error calculation unit 214 of the training unit 1221 calculates the error between the teacher image data and the degradation-restored image data, whose defects have been suppressed in step S1405, according to a loss function in the manner as in step S705 in the first embodiment.

In step S1407, the model updating unit 215 of the training unit 1221 updates the network parameters for the CNNs so as to reduce (minimize) the error obtained in step S1406 in the manner as in step S706 in the first embodiment.

In step S1408, the training unit 1221 determines whether to end the training. The training unit 1221 determines to end the training, for example, if the number of updates of the network parameters reaches a certain count. If the training unit 1221 determines to end the training (YES in step S1408), the degradation restoration training illustrated in FIG. 14A ends. If the training unit 1221 determines not to end the training (NO in step S1408), the processing of the cloud server 1220 returns to step S1404, and, with the processing from step S1404 onward, training using another item of student image data and another item of teacher image data is performed.

Referring next to the flowchart of FIG. 14B, the flow of a degradation restoration process performed by the edge device 1210 will now be described.

In step S1411, the configuration determination unit 1211 determines the number of iterations I of the set of a degradation restoration process and a defect suppression process. The number of iterations I may be a preset value, or any value set by the user may be used.

In step S1412, the edge device 1210 acquires, in the manner as in step S1101 in the second embodiment, the trained model, which is the training result of the degradation restoration training by the cloud server 1220, and input video data subjected to a degradation restoration process. The input video data and the trained model acquired by the edge device 1210 are sent to the acquisition unit 911.

In step S1413, the acquisition unit 911 selects, in the manner as in step S1102 in the second embodiment, N items of input image data from the input video data acquired in step S1412, and generates input concatenated image data concatenated in the channel direction. In the present embodiment, the acquisition unit 911 selects N chronologically consecutive items of input image data from the input video data so as to have a partial overlap between the sets.

In step S1414, the first restoration unit 1212 constructs the same CNN as that used in the training of the training unit 1221 in the manner as in step S1103 in the second embodiment to perform a degradation restoration process on the input concatenated image data, and obtains output concatenated image data. The first restoration unit 1212 then divides the obtained output concatenated image data into items of degradation-restored image data for each time.

In step S1415, the first suppression unit 1213 constructs the same CNN as that used in the training of the training unit 1221, inputs items of degradation-restored image data at the same time to the CNN, and performs defect suppression.

This results in a single item of degradation-restored image data in which defects have been suppressed.

In step S1416, the edge device 1210 determines whether the number of iterations of a degradation restoration process and a defect suppression process has reached I iterations. If the edge device 1210 determines that the number of iterations has reached I iterations (YES in step S1416), the degradation restoration process illustrated in FIG. 14B ends. If the edge device 1210 determines that the number of iterations has not reached I iterations (NO in step S1416), the processing of the edge device 1210 returns to step S1414, and the processing from step S1414 onward is performed.

The description so far is the overall flow of processing performed in the information processing system according to the third embodiment.

In the third embodiment, a degradation restoration process and a defect suppression process are combined into a set, and the set is performed in multiple stages to further reduce the residual fluctuation. As a result, if the degree of degradation of the input video data is great, the residual fluctuation in the temporal direction of the degradation-restoration result can be reduced. The degree of degradation increases mainly when shooting is performed under adverse conditions, such as the noise in a video shot with high sensitivity settings in a low-light environment that is darker than starlight, or the decrease in resolution of a video shot using telephoto lenses that image an object several kilometers away. In the present embodiment, the greater the number of iterations I of the set of a degradation restoration process and a defect suppression process, the greater the effect of reducing the residual fluctuation. The residual fluctuation reduction effect and the processing speed are in a trade-off relationship, and the greater the residual fluctuation reduction effect, the slower the processing speed. This trade-off can be adjusted by the total number of items of input image data K, the number of items N per processing unit, the shift amount M, and the number of iterations I.

In order to reduce the residual fluctuation while maintaining the effect of processing faster than the conventional N-item input 1-item output, it may be necessary to set N, M, and I to satisfy K−2·(N/2)>I(K/M) (*the division result is rounded down) (where N, M, and I are integers satisfying N≤K, 1≤M<N, and 1≤I). For example, if K=90, N=3, M=3, and I=2, the left side becomes 88 and the right side becomes 60, which means that the processing is about 1.5 times faster than N-item input 1-item output.

Although the CNN is used as a defect suppression process in the present embodiment, rule-based processing, such as averaging items of degradation-restored image data at the same time to output a single item of degradation-restored image data, may be performed.

### Fourth Embodiment

In the second embodiment, an example has been described in which fluctuation is reduced by performing a degradation restoration process that inputs N items of degraded image data while shifting each set of N images to overlap, and outputs N items of degradation-restored image data, and combining the obtained restoration results at the same time. Moreover, in the third embodiment, an example has been described in which a degradation restoration process and a defect suppression process implemented in the second embodiment are combined into a set, and the set is performed in multiple stages to reduce the residual fluctuation. In the third embodiment, depending on the degree of degradation of the input video, the multi-stage defect suppression process may result in overcorrection or, conversely, insufficient correction.

In a fourth embodiment, an example will be described in which degradation is appropriately restored by adding a functional unit configured to estimate the amount of degradation of the input video data. Note that descriptions of details common to the above-described embodiments, such as the basic configuration of the information processing system, will be omitted, and different points will be mainly described.

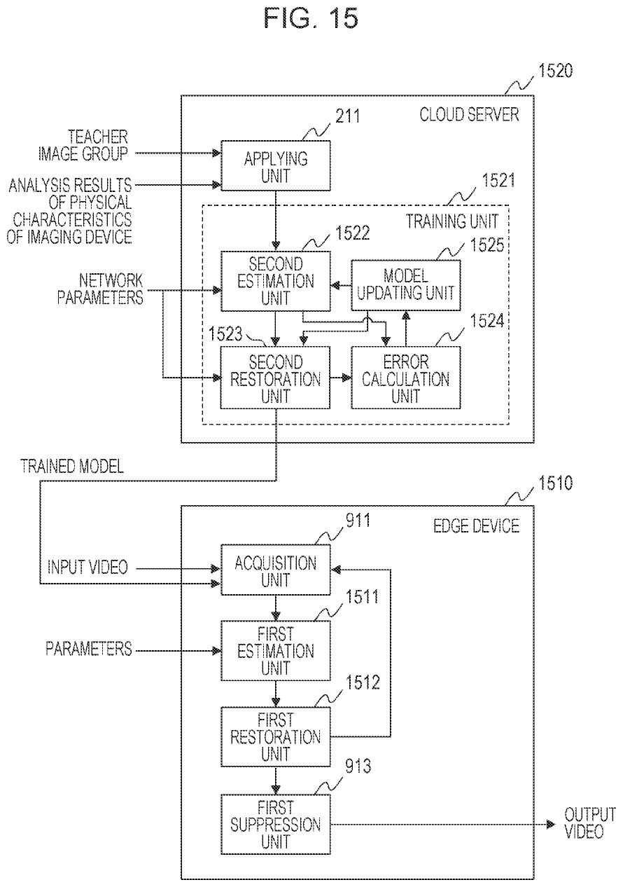

FIG. 15 is a block diagram illustrating an example of the configuration of an information processing system according to the fourth embodiment.

In FIG. 15, components having the same functions as the components illustrated in FIGS. 2 and 9 are given the same reference numerals, and overlapping descriptions are omitted. As illustrated in FIG. 15, an edge device 1510 according to the fourth embodiment has the acquisition unit 911, a first estimation unit 1511, a first restoration unit 1512, and the first suppression unit 913. Moreover, a cloud server 1520 according to the fourth embodiment has the applying unit 211 and a training unit 1521. The training unit 1521 has a second estimation unit 1522, a second restoration unit 1523, an error calculation unit 1524, and a model updating unit 1525. Each functional unit illustrated in FIG. 15 is realized, for example, by the CPU 101 or the CPU 201 executing a computer program for realizing each function. Note that all or some of the functional units illustrated in FIG. 15 may be implemented in hardware.

Each functional unit of the edge device 1510 will be described.

The first estimation unit 1511 is a degradation estimation unit for inference, which uses a trained model acquired from the cloud server 1520 to estimate a degradation amount representing the degree of degradation of N items of input image data. A neural network is used to estimate the amount of degradation. The first estimation unit 1511 inputs the input image data to a CNN, repeatedly performs the convolution operations of filters and the non-linear operations described by equations (1) and (2), and outputs a degradation estimation result. The CNN used here has a structure that receives N items of image data as input and outputs N items of image data.

The first restoration unit 1512 is a degradation restoration unit for inference, which makes a degradation restoration inference for each set of N items of input image data using the trained model acquired from the cloud server 1520 and N degradation estimation results to obtain N items of degradation-restored image data. The greater the degradation amount, that is, the noise amount, the more likely the fluctuation after the noise reduction is to remain, and hence, the shift amount M is set to be small. For example, a lookup table (LUT) of the value of the shift amount M corresponding to each noise amount is retained in advance, and an appropriate value for the shift amount M can be set by referring to the LUT according to the noise amount.

A neural network is used for degradation restoration. The first restoration unit 1512 concatenates N items of input image data and N degradation estimation results in the channel direction. Then, the first restoration unit 1512 inputs the concatenated result to another CNN different from the CNN used in the first estimation unit 1511, repeatedly performs the convolution operations of filters and the non-linear operations described by equations (1) and (2), and outputs a degradation restoration result.

Next, each functional unit of the cloud server 1520 will be described.

The second estimation unit 1522 is a degradation estimation unit for training, which receives training data from the applying unit 211 and estimates the amount of degradation applied to the student image data. The second estimation unit 1522 first inputs the student image data to a first CNN, repeatedly performs the convolution operations of filters and the non-linear operations described by equations (1) and (2), and outputs a degradation estimation result.

The second restoration unit 1523 is a degradation restoration unit for training, which receives the student image data and the degradation estimation result estimated by the second estimation unit 1522, and performs a restoration process on the student image data. The second restoration unit 1523 first inputs the student image data and the degradation estimation result to a second CNN, repeatedly performs the convolution operations of filters and the non-linear operations indicated by equations (1) and (2), and outputs degradation-restored image data.

The error calculation unit 1524 calculates the error between the degradation amount applied to the student image data and the degradation estimation result obtained by the second estimation unit 1522. Here, the applied degradation amount, the student image data, and the degradation estimation result all have the same number of pixels. The error calculation unit 1524 also calculates the error between the teacher image data and the restoration result obtained by the second restoration unit 1523. Here, the teacher image data and the restoration result have the same number of pixels.

The model updating unit 1525 updates the network parameters for the first CNN so as to reduce (minimize) the error between the applied degradation amount and the degradation estimation result, which is calculated by the error calculation unit 1524. The model updating unit 1525 also updates the network parameters for the second CNN so as to reduce (minimize) the error between the teacher image data and the restoration result, which is calculated by the error calculation unit 1524. Although the timing at which the error is calculated is different between the second estimation unit 1522 and the second restoration unit 1523, the timing at which the network parameters are updated is the same.

### Flow of Processing of Overall System

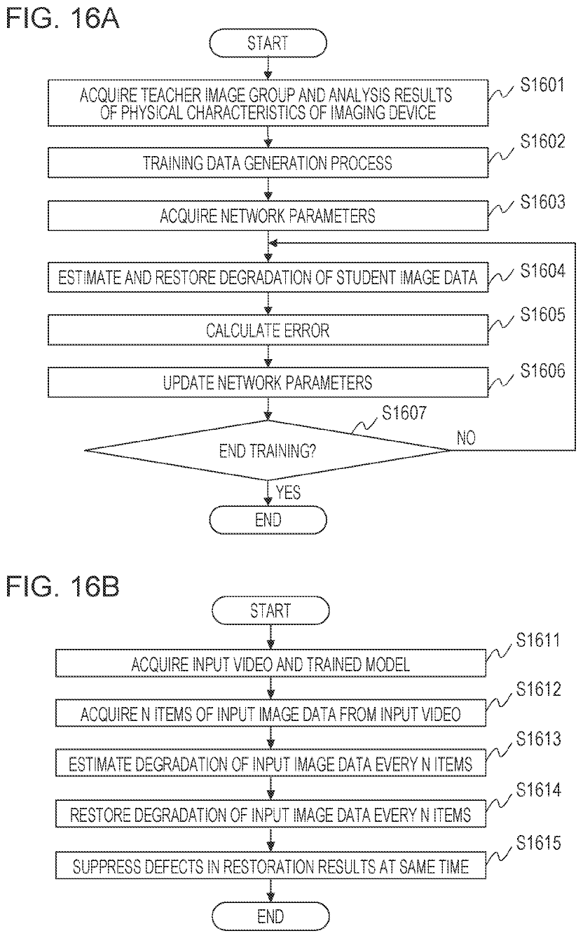

Next, various processes performed in the information processing system according to the fourth embodiment will be described. FIGS. 16A and 16B are flowcharts illustrating examples of processing in the information processing system according to the fourth embodiment. The following description follows the flowcharts of FIGS. 16A and 16B.

Referring to the flowchart of FIG. 16A, the flow of an example of degradation restoration training performed by the cloud server 1520 will be described.

In step S1601, the cloud server 1520 acquires, in the manner as in step S701 in the first embodiment, a teacher image group prepared in advance and the analysis results of the physical characteristics of the imaging device. The data of the teacher image group and the analysis results of the physical characteristics of the imaging device, which are acquired by the cloud server 1520, are sent to the applying unit 211.

In step S1602, the applying unit 211 performs a training data generation process in the manner as in step S702 in the first embodiment.

In step S1603, the cloud server 1520 acquires network parameters to be applied to CNNs for degradation estimation training and degradation restoration training. The network parameters acquired by the cloud server 1520 are sent to the training unit 1521.

In step S1604, the first estimation unit 1511 initializes the weights of the CNN using the network parameters acquired in step S1603, and then estimates the degradation of the student image data generated in step S1602. Then, the second restoration unit 1523 restores the student image data based on the estimation result.

In step S1605, the error calculation unit 1524 respectively calculates the error between the applied degradation amount and the degradation estimation result, and the error between the restoration result and the teacher image data according to a loss function.

In step S1606, the model updating unit 1525 updates the network parameters of the respective CNNs for degradation estimation training and degradation restoration training so as to reduce (minimize) their errors obtained in step S1605.

In step S1607, the training unit 1521 determines whether to end the training. The training unit 1521 determines to end the training, for example, if the number of updates of the network parameters reaches a certain count. If the training unit 1521 determines to end the training (YES in step S1607), the degradation restoration training illustrated in FIG. 16A ends. If the training unit 1521 determines not to end the training (NO in step S1607), the processing of the cloud server 1520 returns to step S1604, and, with the processing from step S1604 onward, training using another item of student image data and another item of teacher image data is performed.

Referring next to the flowchart of FIG. 16B, the flow of an example of a degradation restoration inference made by the edge device 1510 will be described.

In step S1611, the edge device 1510 acquires, in the manner as in step S711 in the first embodiment, the trained model, which is the training result of the degradation restoration training by the cloud server 1520, and input video data subjected to a degradation restoration process. The input video data and the trained model acquired by the edge device 1510 are sent to the acquisition unit 911.

In step S1612, the acquisition unit 911 selects, in the manner as in step S712 in the first embodiment, N items of input image data from the input video data acquired in step S1611, and generates input concatenated image data concatenated in the channel direction.

In step S1613, the first estimation unit 1511 constructs the same CNN as that used in the degradation estimation training of the training unit 1521 and performs degradation estimation of the input image data. The first estimation unit 1511 inputs the input image data to the CNN to which the updated network parameters have been applied, and performs degradation estimation in the same manner as performed in the training unit 1521 to obtain a degradation estimation result.

In step S1614, the first restoration unit 1512 constructs the same CNN as that used in the degradation restoration training of the training unit 1521, sets the shift amount M by referring to the LUT based on the degradation estimation result, and performs degradation restoration of the input image data.

In step S1615, the first suppression unit 913 combines items of degradation-restored image data at the same time obtained in step S1614 to obtain a single item of degradation-restored image data in which defects have been suppressed. Then, the image data whose degradation has been restored is output as output video data.

The description so far is the overall flow of processing performed in the information processing system according to the fourth embodiment.

In the fourth embodiment, degradation is restored based on the degradation estimation result by adding a functional unit configured to estimate the degradation amount of the input video data. Accordingly, even if the sensitivity and exposure value of the camera are changed, the scene is switched, or the object is framed in, the degradation amount of the input video data can be estimated adaptively, and an appropriate degradation restoration process and defect suppression process can be performed according to the results. Although an example in which the shift amount M is set with reference to the LUT based on the degradation amount (noise amount) has been described in the present embodiment, a LUT that sets the shift amount M to prioritize the acceleration of processing or to prioritize the reduction of fluctuation may be provided. At this time, in order to reduce the fluctuation while maintaining the effect of processing faster than the conventional N-item input 1-item output, it may be necessary to create a LUT so that the shift amount M will be 1<M.

Although the shift amount M is set by the first restoration unit 1512 based on the degradation amount in the present embodiment, the number of degraded images N and the number of iterations I may also be retained in the LUT, and the number of images N may be changed and the number of iterations I may be set according to the degradation amount. For example, the greater the amount of degradation, the greater N may be set, or the greater the number of iterations I may be set.

According to some embodiments of the present disclosure, a video degradation restoration process can be performed at a high speed.

### Other Embodiments

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2022-169200, which was filed on Oct. 21, 2022 and which is hereby incorporated by reference herein in its entirety.

What is claimed is:

1. An information processing apparatus comprising:
one or more memories; and
one or more processors, wherein the one or more processors and the one or more memories are configured to:
acquire a plurality of items of input image data; and
output, based on N (N is an integer greater than or equal to 2) items of input image data among the plurality of items of input image data, N items of first image data corresponding to the N items of input image data, processed using a neural network.

2. The information processing apparatus according to claim 1, wherein the one or more processors and the one or more memories are further configured to concatenate the N items of input image data as a set and outputs the N items of first image data for each set.

3. The information processing apparatus according to claim 2, wherein the one or more processors and the one or more memories are further configured to create a plurality of sets of the N items of input image data by selecting from the plurality of items of input image data, shifting in a temporal direction within a range of 1 to N items.

4. The information processing apparatus according to claim 2, wherein the one or more processors and the one or more memories are further configured to concatenate the N items of input image data by overlaying each pixel at same coordinates.

5. The information processing apparatus according to claim 1, wherein the plurality of items of input image data is a plurality of chronologically consecutive items of input image data.

6. The information processing apparatus according to claim 1, wherein the one or more processors and the one or more memories are further configured to acquire a trained model of the neural network.

7. The information processing apparatus according to claim 1, wherein the one or more processors and the one or more memories are further configured to, based on a plurality of items of the first image data output at a same time, output one item of second image data at that time.

8. The information processing apparatus according to claim 7, wherein the one or more processors and the one or more memories are further configured to combine the plurality of items of the first image data at the same time to output one item of the second image data.

9. The information processing apparatus according to claim 7, wherein the one or more processors and the one or more memories are further configured to combine the plurality of items of the first image data at the same time using a neural network to output one item of the second image data.

10. The information processing apparatus according to claim 7, wherein the one or more processors and the one or more memories are further configured to iteratively output N items of first image data corresponding to the N items of input image data and iteratively output one item of second image data at that time.

11. The information processing apparatus according to claim 1, wherein the one or more processors and the one or more memories are further configured to:
estimate an amount of degradation of the N items of input image data; and
output N items of the first image data based on the N items of input image data and the amount of degradation.

12. The information processing apparatus according to claim 1, wherein degradation to be processed includes at least one of noise, compression, low resolution, blur, aberration, defect, and contrast reduction due to an influence of weather at a time of shooting.

13. An information processing apparatus comprising:
one or more memories; and
one or more processors, wherein the one or more processors and the one or more memories are configured to:
apply a degradation factor of image quality to teacher image data to generate student image data;
train a neural network that outputs N (N is an integer greater than or equal to 2) items of degradation-restored image data based on N items of input image data using training data composed of a teacher image group consisting of a plurality of items of the teacher image data and a student image group consisting of a plurality of items of the student image data; and
provide a trained model of the neural network.

14. An information processing method comprising:
acquiring a plurality of items of input image data; and
outputting N (N is an integer greater than or equal to 2) items of image data corresponding to, among the plurality of items of input image data, N items of input image data, processed using a neural network.

15. An information processing method comprising:
applying a degradation factor of image quality to teacher image data to generate student image data;
training a neural network that outputs N (N is an integer greater than or equal to 2) items of degradation-restored image data based on N items of input image data using training data composed of a teacher image group consisting of a plurality of items of the teacher image data and a student image group consisting of a plurality of items of the student image data; and
providing a trained model of the neural network obtained in the training.

16. A non-transitory computer-readable storage medium storing instructions that, when executed by a computer, cause the computer to execute:
acquiring a plurality of items of input image data; and
outputting N (N is an integer greater than or equal to 2) items of image data corresponding to, among the plurality of items of input image data, N items of input image data, processed using a neural network.

17. A non-transitory computer-readable storage medium storing instructions that, when executed by a computer, cause the computer to execute:
applying a degradation factor of image quality to teacher image data to generate student image data;
training a neural network that outputs N (N is an integer greater than or equal to 2) items of degradation-restored image data based on N items of input image data using training data composed of a teacher image group consisting of a plurality of items of the teacher image data and a student image group consisting of a plurality of items of the student image data; and
providing a trained model of the neural network obtained in the training.
